(19) United States
(12) Patent Application Publication
(10) Pub. No.: US 2024/0286354 A1
(43) Pub. Date: Aug. 29, 2024

(54) THREE-DIMENSIONAL MOLDING APPARATUS AND THREE-DIMENSIONAL MOLDING METHOD

(71) Applicant: SONY GROUP CORPORATION, TOKYO (JP)

(72) Inventor: HIROYUKI YANAGISAWA, TOKYO (JP)

(21) Appl. No.: 18/571,434

(22) PCT Filed: Feb. 4, 2022
(86) PCT No.: PCT/JP2022/004360

§ 371 Date: Dec. 18, 2023

(30) Foreign Application Priority Data
Jun. 25, 2021 (JP) 2021-105987

(51) Int. Cl. B29C 64/268; B29C 64/135; B29C 64/386; B33Y 10/00; B33Y 30/00; B33Y 50/00

(52) U.S. Cl. CPC B29C 64/268; B29C 64/135; B29C 64/386; B33Y 10/00; B33Y 30/00; B33Y 50/00

(57) ABSTRACT

A three-dimensional molding apparatus according to an embodiment includes: a laser light source that emits processing light; a phase control unit that generates, based on a predetermined three-dimensional data set, a phase control signal that causes a wavefront shape of the processing light at a predetermined processing position in a photocurable resin bath to be a shape of a three-dimensional surface-shaped body constituting a surface of a three-dimensional molded object corresponding to the three-dimensional data set; and a phase conversion unit that receives the processing light, performs phase modulation of the processing light based on the phase control signal, and emits the processing light to a side of the photocurable resin bath.

### FIELD

Embodiments of the present invention relate to a three-dimensional molding apparatus and a three-dimensional molding method.

### BACKGROUND

Conventionally, a stereolithography apparatus that forms a three-dimensional molded object using a lithography resin (a photocurable resin) that is cured by irradiation of light such as visible light or ultraviolet light is known.

As such a stereolithography apparatus, to start with, a lithography resin is cured and laminated in layer units to form a laminated structure body, an exposure amount of a focused spot is adjusted by changing a laser output, an acoustic-optical modulator (AOM), and a laser scanning speed, and a voxel size at which a lithography material is cured is changed, so that a desired surface structure is obtained for the laminated structure body.

In this case, a bulging effect was avoided by writing the voxel size at which heat accumulation is corrected.

### CITATION LIST

### Patent Literature

Patent Literature 1: JP 2020-519484 A

Patent Literature 2: JP 2002-207202 A

Patent Literature 3: JP 2006-119427 A

### SUMMARY

### Technical Problem

In the conventional technique described above, formation accuracy of the surface structure depends on the voxel size, a galvanometer mirror, an acoustic-optical element (AOM), the accuracy of stage movement, and the like, and there is a problem that the desired surface structure cannot be necessarily formed.

Further, it is difficult to completely eliminate steps in principle in a voxel-unit curing by sequential scanning of a pulse laser, and there is a concern that voxel size control by a laser light output and a sequential scanning speed may decrease a molding speed.

In view of the above problems, embodiments of the present invention are intended to provide a three-dimensional molding apparatus and a three-dimensional molding method capable of realizing a desired surface structure without causing a decrease in the molding speed.

### Solution to Problem

In order to solve the above problem, a three-dimensional molding apparatus includes: a laser light source that emits processing light; a phase control unit that generates, based on a predetermined three-dimensional data set, a phase control signal that causes a wavefront shape of the processing light at a predetermined processing position in a photocurable resin bath to be a shape of a three-dimensional surface-shaped body constituting a surface of a three-dimensional molded object corresponding to the three-dimensional data set; and a phase conversion unit that receives the processing light, performs phase modulation of the processing light based on the phase control signal, and emits the processing light to a side of the photocurable resin bath.

### BRIEF DESCRIPTION OF DRAWINGS

FIG. 1 is a block diagram illustrating a configuration example of a stereolithography apparatus as a three-dimensional molding apparatus of a first embodiment.

FIG. 2 is an external perspective view of an example of a three-dimensional molded object.

FIG. 3 is a cross-sectional view of the three-dimensional molded object.

FIG. 4 is a diagram (part 1) illustrating a relationship between an entire exposure region and an exposable region.

FIG. 5 is a diagram (part 2) illustrating the relationship between the entire exposure region and the exposable region.

FIG. 6 is an explanatory diagram in a case where a three-dimensional surface-shaped body is large and multiple times of exposure are required.

FIG. 7 is an explanatory diagram of the three-dimensional surface-shaped body for each exposure unit.

FIG. 8 is a block diagram illustrating a configuration example of a stereolithography apparatus of a second embodiment.

FIG. 9 is a block diagram illustrating a configuration example of a stereolithography apparatus of a third embodiment.

FIG. 10 is a block diagram illustrating a configuration example of a stereolithography apparatus of a fourth embodiment.

### DESCRIPTION OF EMBODIMENTS

Next, embodiments will be described in detail with reference to the drawings.

### [1] First Embodiment

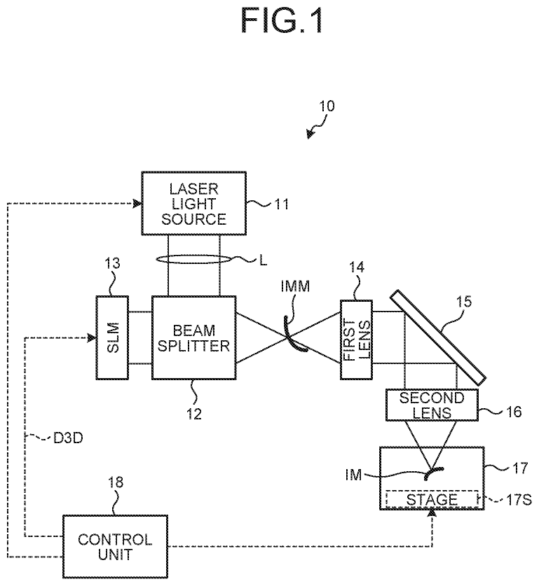

FIG. 1 is a block diagram illustrating a configuration example of a stereolithography apparatus as a three-dimensional molding apparatus of the first embodiment.

As illustrated in FIG. 1, a stereolithography apparatus 10 of the first embodiment includes a laser light source 11, a beam splitter 12, a spatial light modulator (SLM) 13, a first lens 14, a mirror 15, a second lens 16, a photocurable resin bath 17, and a control unit 18.

In the above configuration, the first lens 14, the mirror 15, and the second lens 16 constitute a reduction imaging system (a reduction optical system).

As the laser light source 11, a laser diode is used that emits processing light L having a wavelength capable of curing a lithography resin by exposing a lithography resin liquid as a photocurable resin stored in the photocurable resin bath 17 and utilizing multiphoton (for example, two-photon) absorption.

In this case, examples of a material of the lithography resin include an epoxy resin and an acrylic resin.

The beam splitter 12 guides the processing light L emitted from the laser light source 11 toward a side of the spatial light modulator 13, and guides the processing light L after phase modulation to the mirror 15. Note that, in order to improve efficiency, the processing light L may be incident to the spatial light modulator 13 at an angle without using a beam splitter.

The spatial light modulator 13 performs the phase modulation on the incident processing light L based on a three-dimensional data set D3D input from the control unit 18 to form an image as an intermediate image IMM via the beam splitter 12, and guides the image to the first lens 14 constituting the reduction imaging system.

The first lens 14 functions as a condenser lens, condenses the processing light L and guides it to the mirror 15.

The mirror 15 reflects the processing light L and guides it to the second lens 16.

The second lens 16 functions as an imaging lens, and forms a reduced image IM at a predetermined focal position of the photocurable resin bath 17. As a result, the lithography resin is cured in a three-dimensional shape corresponding to the reduced image IM.

The photocurable resin bath 17 has a water tank shape and can hold a lithography resin liquid. A resin bath may have an upper lid structure that is transparent to the processing light and prevents ingress of oxygen. Further, the lithography resin liquid may be directly held in a space between the second lens and a stage by surface tension.

In this case, in the photocurable resin bath 17, a stage 17S is provided that supports the cured lithography resin and can three-dimensionally (vertical, horizontal, front and back) move in position under control of the control unit 18.

The stage 17S can change a focal position (a molding position) of an effective reduction optical system by being moved in a vertical direction, a horizontal direction, or a front-rear direction.

The control unit 18 functions as a phase control unit, and controls the spatial light modulator 13 to generate and output a three-dimensional data set D3D for forming a three-dimensional molded object to be molded.

In this case, a data format of the three-dimensional data set D3D can be arbitrary, and data capable of expressing a three-dimensional shape including an internal structure may be sufficient.

In the present embodiment, as will be described later, since the three-dimensional molded object of the three-dimensional molded object is treated as being composed of a laminated structure body representing the internal structure thereof and one or a plurality of three-dimensional surface-shaped bodies covering the laminated structure body, a data format capable of representing the laminated structure body and the three-dimensional surface-shaped body is adopted as the data format of the three-dimensional data set D3D.

Further, the control unit 18 controls the laser light source 11 to control an output of the processing light L to be emitted according to the three-dimensional molded object or the lithography resin.

Furthermore, the control unit 18 controls the stage 17S according to a formation state of the three-dimensional molded object to control a curing position of the lithography resin.

Here, prior to describing a specific operation, the configuration of the three-dimensional molded object will be described.

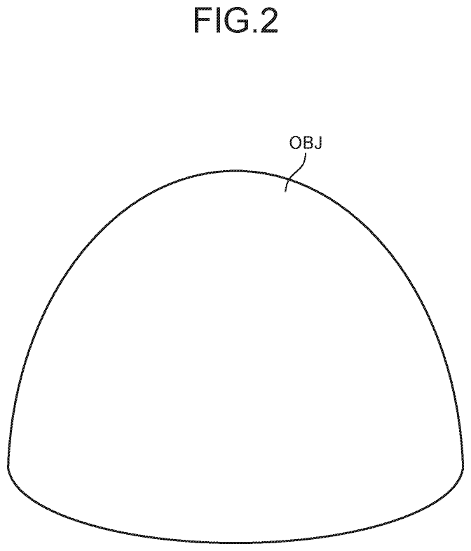

FIG. 2 is an external perspective view of an example of the three-dimensional molded object.

A three-dimensional molded object OBJ in FIG. 2 is a microlens.

The microlens as the three-dimensional molded object OBJ constitutes a so-called plano-convex lens, and has a circular shape in plan view.

In this case, it is preferable that a surface of a convex portion of the microlens draws a smooth curved surface, and optically has no unevenness on the surface. Note that, even when the three-dimensional molded object OBJ is not an optical element, the same applies as long as the three-dimensional molded object OBJ has a smooth surface.

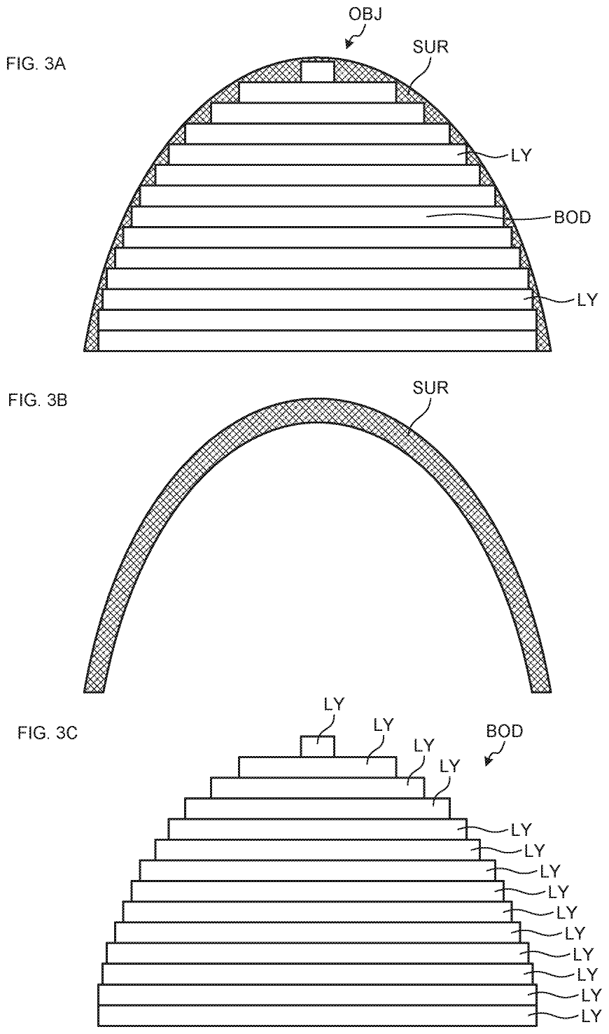

FIG. 3 is a cross-sectional view of the three-dimensional molded object.

In the present embodiment, the three-dimensional molded object OBJ includes a laminated structure body BOD and one or a plurality of three-dimensional surface-shaped bodies SUR covering the laminated structure body BOD.

In this case, the three-dimensional surface-shaped body SUR forms the surface of the three-dimensional molded object OBJ and has a smooth surface.

Here, a joint (a switching surface of an exposure processing) in the three-dimensional surface-shaped body SUR during exposure (when the lithographic resin is cured) will be described.

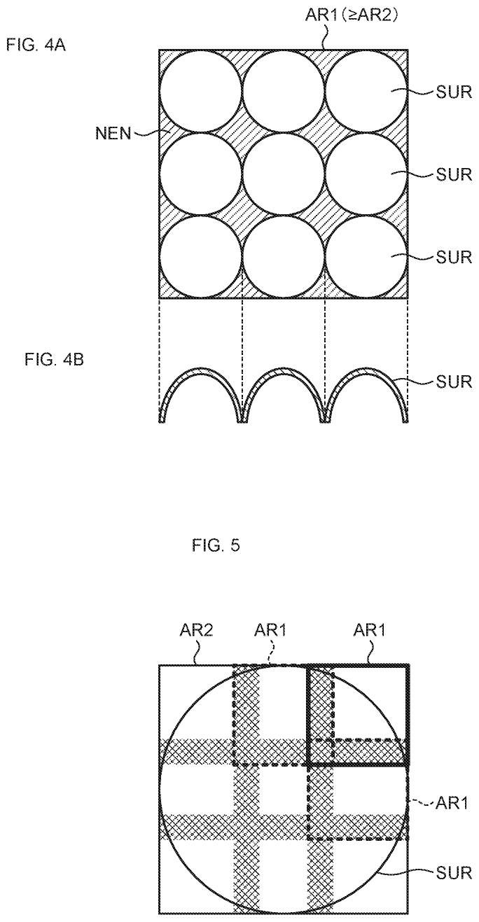

FIG. 4 is a diagram (part 1) illustrating a relationship between an entire exposure region and an exposable region.

As illustrated in FIG. 4(A), in a case where an entire exposure region AR2 of the three-dimensional surface-shaped body SUR is included in an exposable region AR1 that can be exposed by one irradiation of the processing light L, that is, in a case where a shape of a target three-dimensional surface-shaped body SUR falls within the exposable region for one irradiation, as illustrated in the cross-sectional view of FIG. 4(B), the three-dimensional surface-shaped bodies SUR constituting a plurality of (in FIG. 4(A), nine) adjacent microlenses can be integrally exposed without causing a joint of exposure.

FIG. 5 is a diagram (part 2) illustrating the relationship between the entire exposure region and the exposable region.

On the other hand, as illustrated in FIG. 5), in a case where the entire exposure region AR2 of the three-dimensional surface-shaped body SUR is not included in the exposable region AR1 for one irradiation, that is, in a case where the shape of the target dimensional surface-shaped body SUR does not fall within the exposable region for one irradiation, a joint of exposure occurs.

In this case, as illustrated by hatching in FIG. 4(A), in a case where a non-effective region (a region that does not effectively function as the three-dimensional molded object) NEN is included, a joint may be provided in the non-effective region NEN.

Further, in a case where the non-effective region NEN is not included, a joint may be provided in a region where an inclination change of a tangent of the cross section is small. In other words, a joint may be provided in a region where an inclination of the surface does not change abruptly.

Furthermore, as illustrated in FIG. 4, in a case of having a repeated structure, it is considered that in-plane characteristic variation can be suppressed by curing in repeated structure units.

Furthermore, as illustrated by hatching in FIG. 5, by performing exposure while overlapping the adjacent exposable regions AR1 by a predetermined amount, it is possible to prevent an occurrence of an uncured region due to an error in the exposure region.

In this case, since the already cured lithography resin does not affect curing, it is possible to reliably cure the lithography resin.

Next, operations of the first embodiment will be described.

First, the control unit 18 raises the stage 17S to a predetermined position, exposes a layer LY as the lowermost layer constituting the laminated structure body BOD, and sequentially drives the stage 17S in the horizontal direction and the front-rear direction to cure the lithography resin, thereby forming one layer LY on the stage 17S.

Specifically, the processing light L emitted from the laser light source 11 is incident on the beam splitter 12 and guided to the side of the spatial light modulator 13 by the beam splitter 12.

In this case, since it is a stage of forming the laminated structure body BOD, the spatial light modulator 13 guides the processing light L to the side of the beam splitter 12 with a wavefront of the processing light L being flat without performing the phase modulation.

As a result, the beam splitter 12 forms an image as the intermediate image IMM of the layer LY with the processing light L as it is, and guides the image to the first lens 14 constituting the reduction imaging system.

The first lens 14 functions as a condenser lens, condenses the processing light L and guides it to the mirror 15, and the mirror 15 reflects the processing light L and guides it to the second lens 16.

As a result, the second lens 16 functions as an imaging lens, and forms the reduced image IM at a predetermined focal position of the photocurable resin bath 17. As a result, the lithography resin is cured in a shape (a flat plate shape) of the layer LY corresponding to the reduced image IM.

At this time, in consideration of curing time of the lithography resin, the control unit 18 moves the stage 17S in the horizontal direction and the front-rear direction to form the layer LY having a flat plate shape.

When formation of the layer LY is completed, the control unit 18 lowers the stage 17S by one step corresponding to a thickness of the layer LY, and exposes and forms the second layer LY in the same manner.

Thereafter, in the same manner, lowering and exposure of the stage 17S and movement of the stage 17S in the horizontal direction and the front-rear direction are repeated to cure the lithography resin for n layers, thereby forming the laminated structure body BOD.

Subsequently, the control unit 18 proceeds to a process of forming the three-dimensional surface-shaped body SUR.

First, the stage 17S is raised to a predetermined position corresponding to the formation of the three-dimensional surface-shaped body SUR.

Then, the processing light L emitted from the laser light source 11 is incident on the beam splitter 12 and guided to the side of the spatial light modulator 13 by the beam splitter 12.

The spatial light modulator 13 performs the phase modulation on the incident processing light L in accordance with the shape of the three-dimensional surface-shaped body SUR based on the three-dimensional data set D3D input from the control unit 18, forms an image as the intermediate image IMM via the beam splitter 12, and guides the image to the first lens 14 constituting the reduced imaging system.

The first lens 14 functions as a condenser lens, condenses the processing light L and guides it to the mirror 15.

The mirror 15 reflects the processing light L and guides it to the second lens 16.

The second lens 16 functions as an imaging lens, and forms a reduced image IM at a predetermined focal position of the photocurable resin bath 17. As a result, the lithography resin is cured in the shape of the three-dimensional surface-shaped body SUR corresponding to the reduced image IM.

In this case, in a case where the three-dimensional surface-shaped body SUR can be formed by one exposure, the exposure is performed, and the three-dimensional surface-shaped body SUR is integrally formed on the surface of the laminated structure body BOD on the stage 17S as illustrated in FIG. 3(A).

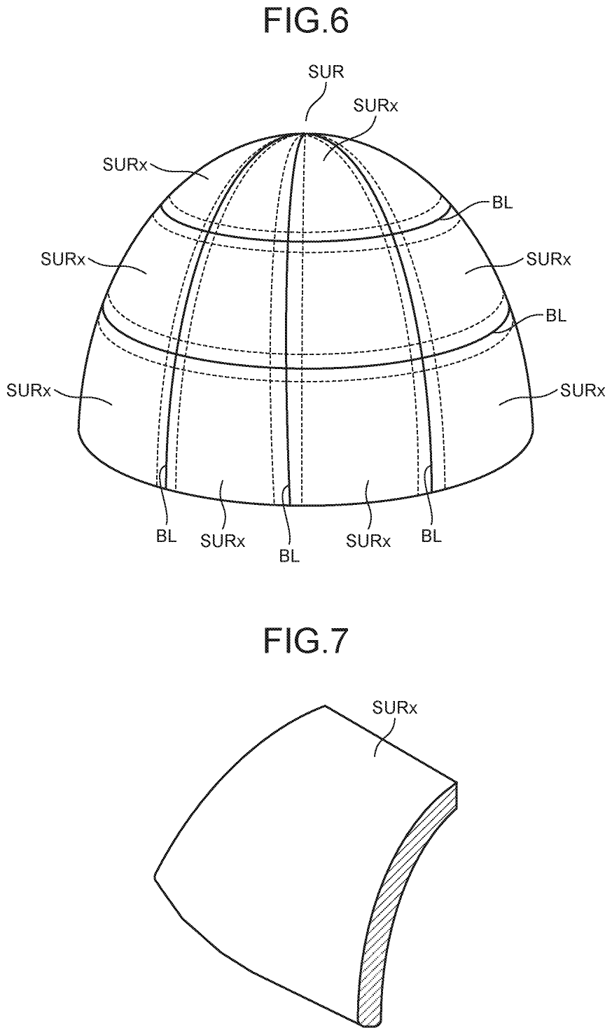

FIG. 6 is an explanatory diagram in a case where the three-dimensional surface-shaped body is large and multiple times of exposure are required.

FIG. 7 is an explanatory diagram of the three-dimensional surface-shaped body for each exposure unit.

On the other hand, as illustrated in FIG. 6, in a case where the three-dimensional surface-shaped body SUR is large and multiple times of exposure are required by dividing the three-dimensional surface-shaped body SUR into a plurality of three-dimensional surface-shaped bodies SURx, the control unit 18 sequentially updates the three-dimensional data set D3D so as to have a desired shape of the three-dimensional surface-shaped body SURx according to an exposure position.

Then, the stage 17S is driven in the vertical direction, the horizontal direction, and the front-back direction so as to be a focal position corresponding to the updated three-dimensional data set D3D, and the lithography resin is cured.

In this case, a boundary line BL defining the joint between the three-dimensional surface-shaped bodies SURx is set to a region where the inclination of the surfaces of the adjacent three-dimensional surface-shaped bodies SURx does not change abruptly.

In other words, a plurality of three-dimensional surface-shaped bodies SURx as illustrated in FIG. 7 are sequentially formed on the surface of the laminated structure body BOD on the stage 17S, and the three-dimensional surface-shaped body SUR is finally formed.

In this case, in FIG. 6, a solid line indicates the shape of an ideal three-dimensional surface-shaped body SUR, but in consideration of an exposure error and the like, and in order to avoid insufficient curing, as indicated by a broken line, a region to be exposed repeatedly is set around the ideal three-dimensional surface-shaped body SURx indicated by the solid line to reliably form the three-dimensional surface-shaped body SUR.

Also in this case, since the already cured lithography resin (another cured three-dimensional surface-shaped body SURx) does not affect the curing, finally, the lithography resin becomes the same as the state of FIG. 3, and can be reliably cured.

As a result, even when the three-dimensional surface-shaped body SUR is formed by multiple times of exposure, a smooth surface shape can be obtained as in a case where the three-dimensional surface-shaped body SUR is formed by one exposure.

As described above, according to the first embodiment, a three-dimensional intermediate image IMM is formed by the spatial light modulator 13, and is reduced and projected by a high magnification lens to form a region (a continuous cured region) exceeding a continuous threshold corresponding to the surface structure of the desired three-dimensional molded object in the lithography resin, thereby obtaining a desired surface structure without steps.

In this case, in the exposure of the three-dimensional surface-shaped body SUR, the processing can be performed by one exposure regardless of fineness of the surface of the three-dimensional molded object in the exposable region for one irradiation, so that a processing speed does not decrease due to the fineness of the surface.

Further, even when the three-dimensional surface-shaped body SUR cannot be formed by one exposure, influence on optical characteristics can be further suppressed by setting a joint portion between the regions to a position where the inclination between the regions (a change in the inclination between the regions) is small during generation of the three-dimensional data set D3D.

Further, as described above, the three-dimensional data set D3D as exposure data includes the data (two-dimensional data) corresponding to the laminated structure body BOD and the data (three-dimensional data) corresponding to the three-dimensional surface-shaped body SUR, and thus, not only the speed of molding processing can be increased, but also data capacity can be reduced, and data compression can be facilitated.

### [2] Second Embodiment

Next, a second embodiment will be described.

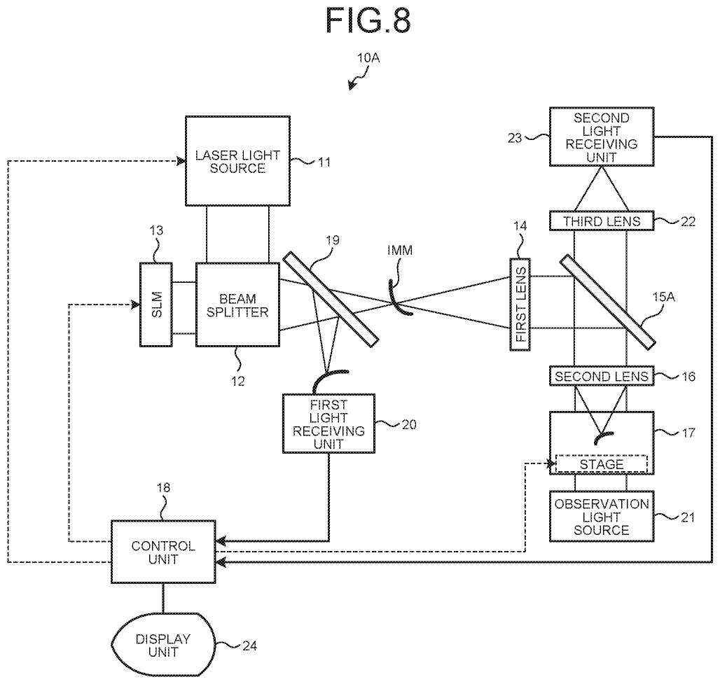

FIG. 8 is a block diagram illustrating a configuration example of a stereolithography apparatus of the second embodiment.

In FIG. 8, parts similar to those of the first embodiment in FIG. 1 are denoted by the same reference numerals.

As illustrated in FIG. 8, a stereolithography apparatus 10A of the second embodiment includes a laser light source 11, a beam splitter 12, a spatial light modulator 13, a first lens 14, a half mirror 15A, a second lens 16, a photocurable resin bath 17, a control unit 18, a half mirror 19, a first light receiving unit 20, an observation light source 21, a third lens 22, a second light receiving unit 23, and a display unit 24.

Also in the above configuration, similarly to the first embodiment, the first lens 14, the half mirror 15A, and the second lens 16 constitute a reduction imaging system (a reduction optical system).

Hereinafter, a configuration different from the configuration of the first embodiment will be mainly described.

The beam splitter 12 guides processing light L emitted from the laser light source 11 toward the side of the spatial light modulator 13, and guides the processing light L after the phase modulation to the half mirror 19.

The half mirror 19 reflects a part of the processing light L after the phase modulation to the first light receiving unit 20 and transmits the rest to the side of the first lens 14.

The first light receiving unit 20 outputs an image signal corresponding to an intermediate image IMM to the control unit 18 based on the incident processing light L. Therefore, an operator of the control unit 18 can grasp a modulation state of the spatial light modulator 13 at the stage of the intermediate image IMM and obtain a better intermediate image IMM.

On the other hand, the processing light L transmitted through the half mirror 19 and transmitted through the first lens 14 that functions as a condenser lens is reflected by the half mirror 15A, and is caused to forms a reduced image IM at a predetermined focal position of the photocurable resin bath 17 by the second lens 16 that functions as an imaging lens. As a result, the lithography resin is cured in a three-dimensional shape corresponding to the reduced image IM.

In parallel with this, observation light emitted from the observation light source 21 is incident in the photocurable resin bath 17, and a part thereof is transmitted through the half mirror 15A and incident in the third lens 22 that functions as an objective lens.

As a result, the third lens 22 forms an image of the lithography resin cured in a three-dimensional shape corresponding to the reduced image IM on the second light receiving unit 23.

The second light receiving unit 23 outputs an image signal corresponding to the image of the lithography resin cured in a three-dimensional shape corresponding to the reduced image IM to the control unit 18 based on the incident observation light.

Therefore, the operator of the control unit 18 can grasp the state of the lithography resin cured in a three-dimensional shape corresponding to the reduced image IM and control the spatial light modulator 13 more realistically.

Here, more specifically, correction of a phase distribution using outputs (images) of the first light receiving unit 20 and the second light receiving unit 23 will be described.

The image obtained by the first light receiving unit 20 corresponding to the intermediate image IMM or the image obtained by the second light receiving unit 23 corresponding to the reduced image (a focused image) IM is compared with a target image, and the phase distribution of the spatial light modulator 13 is updated, so that a focused pattern closer to the target can be obtained.

In this case, as a degree of deviation between an actual image and the target image, for example, an index such as a least square error or a peak signal to noise ratio (PSNR) can be used.

Further, in an update of the phase distribution, for example, a generation position (six axes) of the intermediate image IMM is set as an adjustment value, and the value that decreases the most with a small degree of deviation can be analytically searched.

Further, it is also possible to perform inverse calculation of a propagation path of the processing light L from the obtained image and estimate a phase distribution approaching the target pattern.

For example, it is conceivable to calculate an aberration amount and a blur amount of the optical system from some focused patterns such as a point image, and update the phase distribution in consideration of the phase distribution that compensates for an aberration.

With such a configuration, the deviation (the error) between the three-dimensional molded object to be formed and the three-dimensional molded object to be actually formed can be reduced, and the three-dimensional molded object with higher accuracy can be obtained.

As described above, according to the second embodiment, in addition to the effects of the first embodiment, since the state of the intermediate image IMM and a cured state of the actual lithography resin (the three-dimensional molded object) can be easily grasped, the operator can set more suitable processing conditions (light quantity, phase modulation state, etc.), and processing accuracy and processing yield of the obtained three-dimensional molded object OBJ can be improved.

### [3] Third Embodiment

Next, a third embodiment will be described.

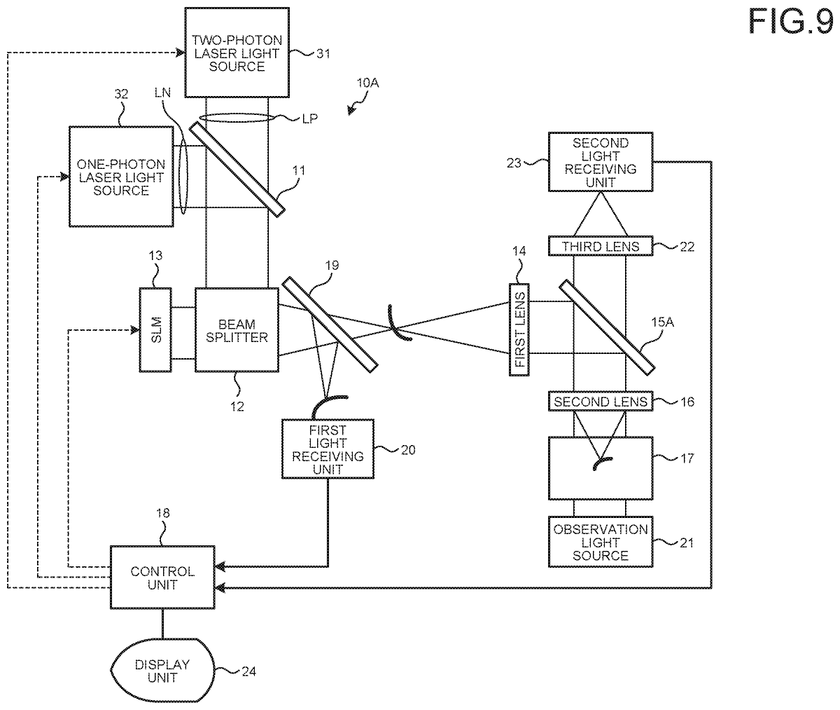

FIG. 9 is a block diagram illustrating a configuration example of a stereolithography apparatus of the third embodiment.

In FIG. 9, parts similar to those of the first embodiment in FIG. 1 are denoted by the same reference numerals.

As illustrated in FIG. 9, a stereolithography apparatus 10B of the third embodiment includes a laser light source 31 having a first wavelength that causes two-photon absorption curing on a resin, a laser light source 32 having a second wavelength that causes one-photon absorption curing on the resin, a half mirror 33, a beam splitter 12, a spatial light modulator (SLM) 13, a first lens 14, a half mirror 15A, a second lens 16, a photocurable resin bath 17, a control unit 18, a half mirror 19, a first light receiving unit 20, an observation light source 21, a third lens 22, a second light receiving unit 23, and a display unit 24.

Also in the above configuration, similarly to the first embodiment, the first lens 14, the half mirror 15A, and the second lens 16 constitute a reduction imaging system (a reduction optical system).

Hereinafter, a configuration different from the configuration of the first embodiment will be basically described.

A two-photon laser light source 31 emits first processing light L1 corresponding to the processing light L in the first embodiment.

A one-photon laser light source 32 emits second processing light L2 that has processing accuracy lower than that of the first processing light L1 but can process a large area. Therefore, it is more suitable for exposure of the laminated structure body BOD.

The half mirror 33 transmits the first processing light L1 emitted from the two-photon laser light source 31, reflects the second processing light L2 emitted from the one-photon laser light source 32, and guides the first processing light L1 and the second processing light L2 to the beam splitter 12.

The beam splitter 12 guides the first processing light L1 and the second processing light L2 to the side of the spatial light modulator 13, and guides the first processing light L1 and the second processing light L2 after the phase modulation to the half mirror 19.

The half mirror 19 reflects a part of the first processing light L1 and the second processing light L2 after the phase modulation to the first light receiving unit 20, and transmits the rest to the side of the first lens 14.

The first light receiving unit 20 outputs an image signal corresponding to an intermediate image IMM to the control unit 18 based on the incident first processing light L1 and second processing light L2. Therefore, an operator of the control unit 18 can grasp a modulation state of the spatial light modulator 13 at the stage of the intermediate image IMM and obtain a better intermediate image IMM.

On the other hand, processing light LP and processing suppression light NP transmitted through the half mirror 19 and transmitted through the first lens 14 that functions as a condenser lens are reflected by the half mirror 15A, and is caused to form a reduced image IM at a predetermined focal position of the photocurable resin bath 17 by the second lens 16 that functions as an imaging lens. As a result, the lithography resin is cured in a three-dimensional shape corresponding to the reduced image IM.

In this case, a large area portion is exposed with the second processing light L2, and a small area portion is exposed with the first processing light L1, so that a high-accuracy three-dimensional molded object OBJ can be formed at a higher speed.

In parallel with this, observation light emitted from the observation light source 21 is incident in the photocurable resin bath 17, and a part thereof is transmitted through the half mirror 15A and incident in the third lens 22 that functions as an objective lens.

As a result, the third lens 22 forms an image of the lithography resin cured in a three-dimensional shape corresponding to the reduced image IM on the second light receiving unit 23.

The second light receiving unit 23 outputs an image signal corresponding to the image of the lithography resin cured in a three-dimensional shape corresponding to the reduced image IM to the control unit 18 based on the incident observation light.

Therefore, the operator of the control unit 18 can grasp the state of the lithography resin cured in a three-dimensional shape corresponding to the reduced image IM and control the spatial light modulator 13 more realistically.

As described above, according to the third embodiment, in addition to the effects of the first embodiment and the second embodiment, it is possible to obtain a three-dimensional molded object OBJ having a more complicated structure by causing the processing light L1 and the processing light L2 to cooperate with each other.

### [3.1] First Modification of Third Embodiment

In the above description, the two-photon laser light source 31 and the one-photon laser light source 32 are used as the laser light sources, but in addition to these, contrary to the processing light L1 and L2, by providing a processing suppression laser light source that emits processing suppression light NP (with a wavelength different from the processing light L1 and L2) that prevents the lithography resin from curing, the curing of the lithography resin is inhibited at the position where the processing suppression light NP is irradiated, so that it is also possible to form a three-dimensional molded object OBJ with a complicated structure that cannot be realized only with the processing lights L1 and L2.

As described above, according to the first modification of the third embodiment, in addition to the effects of the first embodiment and the second embodiment, it is possible to obtain a three-dimensional molded object OBJ having a more complicated structure by causing the processing lights L1 and L2 and the processing suppression light LN to cooperate with each other.

### [3.2] Second Modification of Third Embodiment

In the above description, the two-photon laser light source 31 and the one-photon laser light source 32 are used as the laser light source, but instead of the one-photon laser light source 32, it is also possible to provide a processing suppression laser light source that emits processing suppression light NP that prevents the lithography resin from curing, contrary to the processing light L1.

According to this configuration, the processing speed is reduced as compared with the modification of the third embodiment, but a three-dimensional molded object OBJ having a complicated shape can be obtained with a simpler configuration.

### [4] Fourth Embodiment

The fourth embodiment is an embodiment in a case where the stereolithography apparatus of the first embodiment is further simplified and configured at a lower cost.

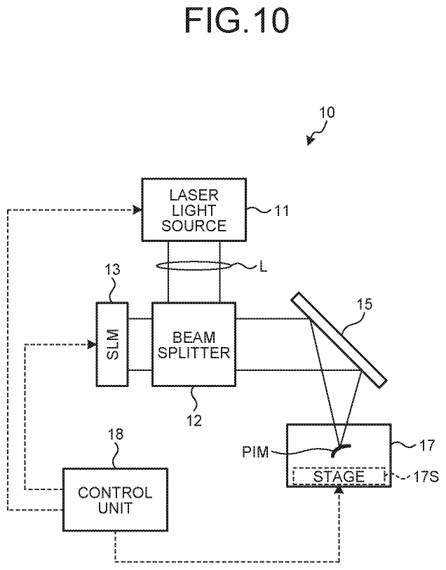

FIG. 10 is a block diagram illustrating a configuration example of a stereolithography apparatus of the fourth embodiment.

In FIG. 10, parts similar to those of the first embodiment in FIG. 1 are denoted by the same reference numerals.

As illustrated in FIG. 10, a stereolithography apparatus 10C of the fourth embodiment includes a laser light source 11, a beam splitter 12, a spatial light modulator (SLM) 13, a first lens 14, a mirror 15, a photocurable resin bath 17, and a control unit 18.

The beam splitter 12 guides the processing light L emitted from the laser light source 11 toward a side of the spatial light modulator 13, and guides the processing light L after phase modulation to the mirror 15.

The spatial light modulator 13 performs phase modulation on the incident processing light L based on a three-dimensional data set D3D input from the control unit 18 and guides the processing light L to the mirror 15 via the beam splitter 12.

The mirror 15 reflects the processing light L and forms an image at a predetermined position of the photocurable resin bath 17. As a result, the lithography resin is cured in a three-dimensional shape corresponding to a projection image PIM.

As described above, according to the fourth embodiment, since stereolithography is performed based on the projection image PIM by the spatial light modulator 13, the processing accuracy is lower than in other embodiments since it depends on modulation accuracy of the spatial light modulator 13, however, it is not necessary to provide a reduction optical system or the like, so that the configuration of the apparatus can be simplified, the cost of the apparatus can be reduced, and maintenance can be facilitated.

### [5] Modifications of Embodiment

### [5.1] First Modification

In the above description, although it has been described that a projection magnification of the intermediate image IMM obtained by the spatial light modulator 13 is fixed, by providing a magnification varying mechanism capable of changing the projection magnification of the intermediate image IMM, it is possible to increase the processing speed.

### [5.2] Second Modification

In the above description, although the stage 17S can be driven in three axial directions of the vertical direction, the horizontal direction, and the front-rear direction, by further providing an inclination correction mechanism of the stage 17S, resolution can be improved with higher accuracy.

### [5.3] Third Modification

Although focus adjustment has not been described in the above description, it is possible to improve resolution with higher accuracy by providing a focus adjustment mechanism.

### [5.4] Fourth Modification

In the above description, the observation light source is provided to grasp the cured state, but instead of this, a reference laser irradiation mechanism for irradiating a reference laser is provided, and inclination correction and focus adjustment of the stage 17S are performed, so that resolution can be improved with higher accuracy.

Further, it is also possible to configure such that the inclination correction and focus adjustment are automatically performed based on the state of the reference laser of the reference laser irradiation mechanism.

### [6] Other Aspects of Embodiments

Furthermore, the present technology can have the following aspects (configurations).

(1)

A three-dimensional molding apparatus, comprising:
a laser light source that emits processing light;
a phase control unit that generates, based on a predetermined three-dimensional data set, a phase control signal that causes a wavefront shape of the processing light at a predetermined processing position in a photocurable resin bath to be a shape of a three-dimensional surface-shaped body constituting a surface of a three-dimensional molded object corresponding to the three-dimensional data set; and
a phase conversion unit that receives the processing light, performs phase modulation of the processing light based on the phase control signal, and emits the processing light to a side of the photocurable resin bath.
   (2)

The three-dimensional molding apparatus according to (1), further comprising
a reduction optical system that reduces an intermediate image obtained by condensing the processing light emitted from the phase conversion unit.
   (3)

The three-dimensional molding apparatus according to (2), further comprising
a light receiving unit that receives a part of the processing light emitted from the phase conversion unit to obtain the intermediate image.
   (4)

The three-dimensional molding apparatus according to any one of (1) to (3), wherein
a wavefront shape of the processing light is a shape at least partially overlapping along a surface of the three-dimensional surface-shaped body relative to another three-dimensional surface-shaped body formed adjacent to one of the three-dimensional surface-shaped body corresponding to the wavefront shape.
   (5)

The three-dimensional molding apparatus according to any one of (1) to (4), wherein
the three-dimensional molded object includes a laminated structure body and one or a plurality of the three-dimensional surface-shaped bodies covering the laminated structure body.
   (6)

The three-dimensional molding apparatus according to any one of (1) to (4), wherein
the three-dimensional molded object includes a laminated structure body and a plurality of the three-dimensional surface-shaped bodies covering the laminated structure body, and
the phase control unit sets a boundary of the adjacent three-dimensional surface-shaped bodies to a region where an inclination of surfaces of the three-dimensional surface-shaped bodies does not change abruptly.
   (7)

The three-dimensional molding apparatus according to any one of (1) to (4), wherein
the three-dimensional molded object includes a laminated structure body and a plurality of the three-dimensional surface-shaped bodies covering the laminated structure body, and
when a non-effective region that does not effectively function as the three-dimensional molded object is included in an exposable region that can be exposed by one irradiation of the processing light, the phase control unit sets a boundary of the three-dimensional surface-shaped body that is adjacent to the non-effective region.
   (8)

A three-dimensional molding method executed by a three-dimensional molding apparatus including a laser light source that emits processing light, and a phase conversion unit that receives the processing light, performs phase modulation of the processing light based on a phase control signal, and emits the processing light to a side of the photocurable resin bath, the three-dimensional molding method comprising:
a process of inputting a predetermined three-dimensional data set corresponding to a predetermined three-dimensional molded object; and
a process of generating, based on the three-dimensional data set, a phase control signal that causes a wavefront shape of the processing light at a predetermined processing position in a photocurable resin bath to be a shape of a three-dimensional surface-shaped body constituting a surface of a three-dimensional molded object corresponding to the three-dimensional data set.
   (9)

The three-dimensional molding method according to (8), comprising
a process of reducing an intermediate image obtained by condensing the processed light emitted from the phase conversion unit to form an image in the photocurable resin bath.
   (10)

The three-dimensional molding method according to (9), comprising
a process of receiving a part of the processing light emitted from the phase conversion unit to obtain the intermediate image.
   (11)

The three-dimensional molding method according to any one of (8) to (10), wherein
a wavefront shape of the processing light is a shape at least partially overlapping along a surface of the three-dimensional surface-shaped body relative to another three-dimensional surface-shaped body formed adjacent to one three-dimensional surface-shaped body corresponding to the wavefront shape.
   (12)

The three-dimensional molding method according to any one of (8) to (11), wherein
the three-dimensional molded object includes a laminated structure body and a plurality of the three-dimensional surface-shaped bodies covering the laminated structural body, and
the process of generating the phase control signal includes a process of setting a boundary of the adjacent three-dimensional surface-shaped bodies to a region where an inclination of the surfaces of the three-dimensional surface-shaped bodies does not change abruptly.
   (13)

The three-dimensional molding method according to any one of (8) to (11), wherein
the three-dimensional molded object includes a laminated structure body and a plurality of the three-dimensional surface-shaped bodies covering the laminated structure body, and
in a case where a non-effective region that does not effectively function as the three-dimensional molded object is included in an exposable region that can be exposed by one irradiation of the processing light, a boundary of the three-dimensional surface-shaped body that is adjacent to the non-effective region is set in the process of generating the phase control signal.

### REFERENCE SIGNS LIST

10, 10A, 10B, 10C STEREOLITHOGRAPHY APPARATUS
11 LASER LIGHT SOURCE
12 BEAM SPLITTER
13 SPATIAL LIGHT MODULATOR
14 FIRST LENS
15 MIRROR
15A HALF MIRROR
16 SECOND LENS
17 PHOTOCURABLE RESIN BATH
17S STAGE
18 CONTROL UNIT
19 HALF MIRROR
20 FIRST LIGHT RECEIVING UNIT
21 OBSERVATION LIGHT SOURCE
22 THIRD LENS
23 SECOND LIGHT RECEIVING UNIT
24 DISPLAY UNIT
31 TWO-PHOTON LASER LIGHT SOURCE
32 ONE-PHOTON LASER LIGHT SOURCE
33 HALF MIRROR
AR1 EXPOSABLE REGION
AR2 ENTIRE EXPOSURE REGION
BL BOUNDARY LINE
BOD LAMINATED STRUCTURE BODY
D3D THREE-DIMENSIONAL DATA SET
L1 FIRST PROCESSING LIGHT
L2 SECOND PROCESSING LIGHT
IM REDUCED IMAGE
IMM INTERMEDIATE IMAGE
L PROCESSING LIGHT
LY LAYER
NEN NON-EFFECTIVE REGION
NP PROCESSING SUPPRESSION LIGHT
OBJ THREE-DIMENSIONAL MOLDED OBJECT
PIM PROJECTION IMAGE
SUR THREE-DIMENSIONAL SURFACE-SHAPED BODY
SURx THREE-DIMENSIONAL SURFACE-SHAPED BODY

1. A three-dimensional molding apparatus, comprising:
a laser light source that emits processing light;
a phase control unit that generates, based on a predetermined three-dimensional data set, a phase control signal that causes a wavefront shape of the processing light at a predetermined processing position in a photocurable resin bath to be a shape of a three-dimensional surface-shaped body constituting a surface of a three-dimensional molded object corresponding to the three-dimensional data set; and
a phase conversion unit that receives the processing light, performs phase modulation of the processing light based on the phase control signal, and emits the processing light to a side of the photocurable resin bath.

2. The three-dimensional molding apparatus according to claim 1, further comprising
a reduction optical system that reduces an intermediate image obtained by condensing the processing light emitted from the phase conversion unit.

3. The three-dimensional molding apparatus according to claim 2, further comprising
a light receiving unit that receives a part of the processing light emitted from the phase conversion unit to obtain the intermediate image.

4. The three-dimensional molding apparatus according to claim 1, wherein
a wavefront shape of the processing light is a shape at least partially overlapping along a surface of the three-dimensional surface-shaped body relative to another three-dimensional surface-shaped body formed adjacent to one of the three-dimensional surface-shaped body corresponding to the wavefront shape.

5. The three-dimensional molding apparatus according to claim 1, wherein
the three-dimensional molded object includes a laminated structure body and one or a plurality of the three-dimensional surface-shaped bodies covering the laminated structure body.

6. The three-dimensional molding apparatus according to claim 1, wherein
the three-dimensional molded object includes a laminated structure body and a plurality of the three-dimensional surface-shaped bodies covering the laminated structure body, and
the phase control unit sets a boundary of the adjacent three-dimensional surface-shaped bodies to a region where an inclination of surfaces of the three-dimensional surface-shaped bodies does not change abruptly.

7. The three-dimensional molding apparatus according to claim 1, wherein
the three-dimensional molded object includes a laminated structure body and a plurality of the three-dimensional surface-shaped bodies covering the laminated structure body, and
when a non-effective region that does not effectively function as the three-dimensional molded object is included in an exposable region that can be exposed by one irradiation of the processing light, the phase control unit sets a boundary of the three-dimensional surface-shaped body that is adjacent to the non-effective region.

8. A three-dimensional molding method executed by a three-dimensional molding apparatus including a laser light source that emits processing light, and a phase conversion unit that receives the processing light, performs phase modulation of the processing light based on a phase control signal, and emits the processing light to a side of the photocurable resin bath, the three-dimensional molding method comprising:
a process of inputting a predetermined three-dimensional data set corresponding to a predetermined three-dimensional molded object; and
a process of generating, based on the three-dimensional data set, a phase control signal that causes a wavefront shape of the processing light at a predetermined processing position in a photocurable resin bath to be a shape of a three-dimensional surface-shaped body constituting a surface of a three-dimensional molded object corresponding to the three-dimensional data set.
